(19) United States
(12) Patent Application Publication
(10) Pub. No.: US 2026/0370098 A1
(43) Pub. Date: Nov. 19, 2026

(54) ENVIRONMENTAL CONDITION MONITORING SYSTEM FOR VARIABLE FREQUENCY DRIVES

(71) Applicant: INNOMOTICS GMBH, 90441 Nümberg (DE)

(72) Inventors: Liviu Mihalache, Valencia, PA (US); GRIGORIY PUCHKAREV, Tarentum, PA (US)

(73) Assignee: INNOMOTICS GMBH, 90441 Nümberg (DE)

(21) Appl. No.: 19/477,691

(22) PCT Filed: Apr. 26, 2023
(86) PCT No.: PCT/US2023/019888

§ 371 Date: Oct. 22, 2025

(51) Int. Cl. H02K 11/33

(52) U.S. Cl. CPC H02K 11/33; H02K 2211/03

(57) ABSTRACT

A sensor board (400) including a plurality of on-board sensors (404) configured to measure different environmental conditions, a network interface (408) for connecting to one or more off-board sensor(s), a processor (412) configured to receive and process data in different data formats from the plurality of on-board sensors (404) and the one or more off-board sensor(s), and an interface (416) for connecting to a control system (450) or data processing system, wherein acquired data in the different data formats are transmitted to the control system (450) or data processing system in a unified data format.

### BACKGROUND

### 1. Field

Aspects of the present disclosure relate to a variable frequency drive, also referred to as VFD, that powers an electric motor driving a load such as pump, compressor, fan, reciprocating compressor system etc. Throughout the specification, the terms “drive”, “drive system”, “multilevel power converter”, “converter”, “power supply” and “variable frequency drive (VFD)” can be used interchangeably.

### 2. Description of the Related Art

Medium voltage variable frequency drives, such as for example multilevel power converters are used in the applications of medium voltage alternating current (AC) drives, flexible AC transmission systems (FACTS), and High Voltage DC (HVDC) transmission systems, because single power semiconductor devices cannot handle high voltage. Multilevel converters typically include a plurality of power cells for each phase, each power cell including an inverter circuit having semiconductor switches that are capable of altering the voltage output of the individual cells. One example of a multilevel power converter is a cascaded H-bridge converter system having a plurality of H-bridge cells as described for example in U.S. Pat. No. 5,625,545 to Hammond, the content of which is herein incorporated by reference in its entirety.

Another example of a multilevel power converter is a modular multilevel converter system having a plurality of M2C or M2LC subsystems. The M2C or M2LC subsystems are herein also referred to as M2C or M2LC cells or simply as power cells. The M2LC topology is popular in medium to high voltage applications since it provides several advantages over other topologies, for example simple process of scaling the number of output voltage levels by a linear addition of identical cells, capacitor free direct current (DC)-link, continuous link currents, reduced voltage rating of the switches and redundant switching operations. However, the M2C or M2LC cells are not independently supplied from isolated voltage sources or secondary windings. The cells are typically supplied from a common DC link via for example AC/DC rectifier systems or batteries, wherein for a given cell, the amount of energy processed at the two terminals depends on the amount of energy supplied to the cell by the link it is connected to and to some extent the ability of the cell to store and release energy.

Further, drive systems include a plurality of sensors to monitor various characteristics and values of the drive system. For example, the sensors include sensor for measuring and monitoring input voltage, output voltage, input current, output current of the power converter, internal temperatures the transformer and/or power converter and/or cooling assemblies, as well as other environmental conditions such as relative humidity, barometric pressure, sound level, various chemical gas concentrations, etc. The sensors provide sensor data, such as values and/or measurements of temperature, vibration, current and voltage via data bus to the control system. However, the multiple sensors may comprise different communication formats and each sensor is individually wired and communicated with, resulting in a solution that is not optimized for costs and reliability.

### SUMMARY

To facilitate an understanding of embodiments, principles, and features of the present disclosure, they are explained hereinafter with reference to implementation in illustrative embodiments. In particular, they are described in the context of being a drive system, such as a medium voltage (MV) variable frequency drive (VFD) including multicell power supplies including modular multilevel converter systems and cascaded H-bridge converter systems. Like reference numerals represent like elements throughout.

More specifically, a first aspect of the present disclosure provides a sensor board comprising a plurality of on-board sensors configured to measure different environmental conditions, a network interface for connecting to one or more off-board sensor(s), a processor configured to receive and process data in different data formats from the plurality of on-board sensors and the one or more off-board sensor(s), and an interface for connecting to a control system or data processing system, wherein acquired data in the different data formats are transmitted to the control system or data processing system in a unified data format.

A second aspect of the present disclosure provides a drive system comprising a power circuit comprising a plurality of power cells supplying power to output phases (A, B, C), a control system in communication with the plurality of power cells and controlling operation of the plurality of power cells, at least one sensor board comprising a plurality of on-board sensors configured to measure different environmental conditions, a network interface for connecting to one or more off-board sensor(s), a processor configured to receive and process data in different data formats from the plurality of on-board sensors and the one or more off-board sensor(s), and an interface for connecting to a control system or data processing system, wherein acquired data in the different data formats are transmitted to the control system or data processing system in a unified data format.

### BRIEF DESCRIPTION OF THE DRAWINGS

FIG. 1 illustrates a schematic diagram of a known basic configuration of a cascaded H-bridge converter system in accordance with an exemplary embodiment disclosed herein.

FIG. 2 illustrates a schematic diagram of another known basic configuration of a cascaded H-bridge converter system in accordance with an exemplary embodiment disclosed herein.

FIG. 3 illustrates a schematic of a basic configuration of a modular multilevel converter system in accordance with an exemplary embodiment described herein.

FIG. 4 illustrates a schematic diagram of a sensor board for a drive system in accordance with an exemplary embodiment of the present disclosure.

FIG. 5 illustrates a schematic diagram of multiple sensor board wired in a daisy chain connection in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being a drive system, such as a medium voltage (MV) variable frequency drive including multi-cell power supplies including modular multilevel converter systems and cascaded H-bridge converter systems. Like reference numerals represent like elements throughout.

As used herein, a “medium voltage” is a voltage of greater than about 690V and less than about 69 kV, and a “low voltage” is a voltage less than about 690V. A person of ordinary skill in the art will understand that other voltage levels may be specified as “medium” voltage and “low voltage”. For example, in some embodiments, a “medium voltage” may be a voltage between about 3 kV and about 69 kV, and a “low voltage” may be less than about 3 kV.

The components and materials described hereinafter as making up the various embodiments are intended to be illustrative and not restrictive. Many suitable components and materials that would perform the same or a similar function as the materials described herein are intended to be embraced within the scope of embodiments of the present invention.

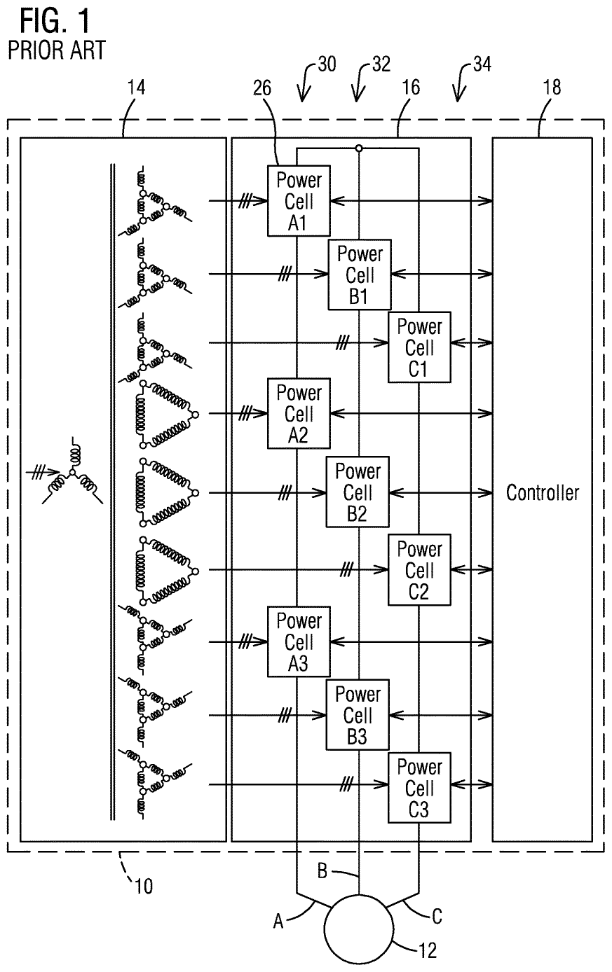

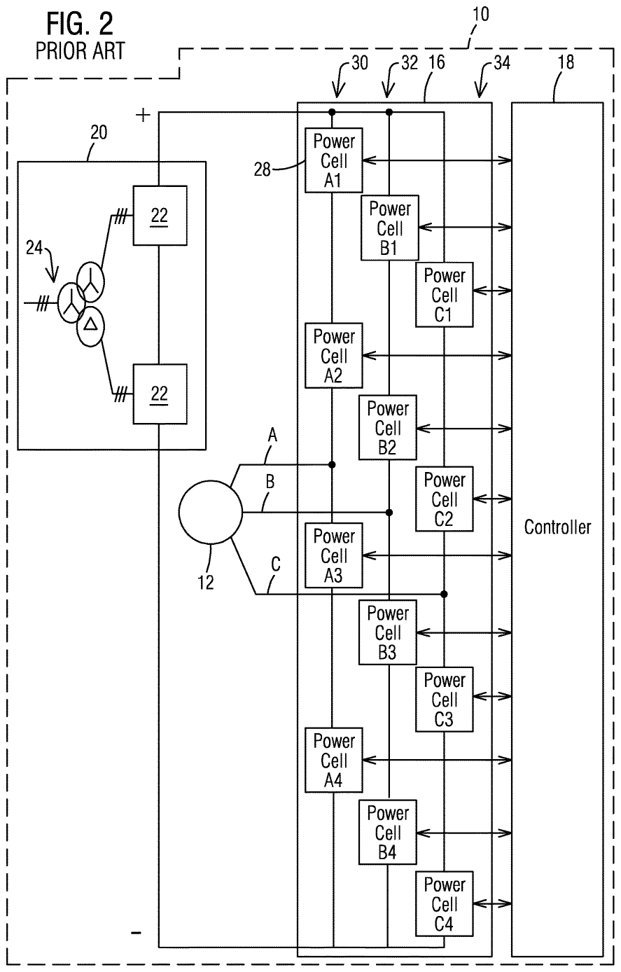

FIG. 1 and FIG. 2 each illustrate a schematic of a known multi-cell power supply 10, specifically a cascaded H-bridge converter system that receives three-phase power from an alternating current (AC) source, and delivers power to a load 12, e.g., a three-phase AC motor.

With reference to FIG. 1, the multi-cell power supply 10 includes a transformer 14, a power circuit 16, and a controller 18, herein also referred to as control system. The transformer 14 includes a primary winding that excites nine secondary windings, and power circuit 16 includes multiple printed circuit board (PCB) power cells 26, herein simply referred to as power cells 26, that are operably coupled to the secondary windings, respectively, of the transformer 14. As the power supply 10 comprises nine secondary windings, and a power cell 26 is operably coupled to each secondary winding, the power supply 10 comprises nine power cells 26. Of course, the power supply 10 can comprise more or less than nine power cells 26 and/or more or less than nine secondary windings depending on a type of the power supply 10 and/or a type of the load 12 coupled to the power supply 10.

The power cells 26 can be rated for lower voltages and are configured to provide a medium voltage output to the load 12. Each output phase A, B, C of the power circuit 16 is fed by a group of series-connected power cells 26. Outputs of the power cells 26 are coupled in series in a first phase group 30, at second phase group 32, and a third phase group 34. Each phase output voltage is a sum of the output voltages of the power cells 26 in the respective phase group 30, 32 and 34. For example, the first phase group 30 comprises power cells 26 labelled A1, A2 and A3, wherein the phase output voltage of the output phase A is the sum of the output voltages of the power cells A1, A2 and A3. The same applies to output phase B and power cells B1, B2, B3, and output phase C and power cells C1, C2, C3. In this regard, the power circuit 16 delivers a medium voltage output to load 12 using lower voltage rated power cells 26 that include components rated to lower voltage standards. Each power cell 26 is coupled, e.g., for example via an optical fiber communication link, to controller 18, which may use current feedback and voltage feedback to control operation of the power cells 26.

As illustrated in FIG. 2, a multi-cell power supply 10 includes three-phase AC power supply 20, a power circuit 16, and a controller 18. The three-phase AC power supply 20 includes two diode bridges 22 which are each connected on the AC voltage side to secondary windings of a power converter transformer 24 and are electrically connected in series on a direct current (DC) voltage side. A positive and a negative DC voltage bus are provided for the parallel connection of these phase groups. The power circuit 16 includes power cells 28 that are coupled to the DC voltage bus created by the power supply 20. The power cells 28 are for example lower voltage rated and are configured to provide medium voltage output to load 12. Although the load 12 may be illustrated as being within the multi-cell power supply 10, the load 12 is not part of the multi-cell power supply 10. Rather, the load 12 is separate from, and connected to, the multi-cell power supply 10, as more clearly shown in FIG. 1.

Each output phase A, B, C of the power circuit 16 is fed by a group of series-connected power cells 28, also labelled A1-A4, B1-B4 and C1-C4 with reference to the output phases A, B, C. The power cells 28 are coupled in series in a first phase group 30, a second phase group 32, and a third phase group 34. Each phase output voltage is a sum of the output voltages of the power cells 28 in the phase group 30, 32 and 34 as described before with reference to FIG. 1. The power circuit 16 delivers a medium voltage output to the load 12 using lower voltage rated power cells 28 that include components rated to lower voltage standards. Each power cell 28 is coupled, e.g., for example via optical fiber communication link(s), to the controller 18, which can use current feedback and voltage feedback to control operation of the power cells 28.

It should be noted that in FIG. 1 and FIG. 2 the number of power cells 26, 28 in each phase group 30, 32, 34 can be between 2 and 12 to provide different medium voltage outputs as required by the load 12. As noted with reference to FIG. 1, the number of secondary windings of transformer 14 matches the number of power cells 26. In the embodiment of FIG. 2, the number of diode bridges and transformer secondary windings can vary from 1 to 6 to allow for harmonic cancellation on the primary side of the transformer 24. It will be appreciated by those of ordinary skill in the art that other cell counts, and diode bridge counts may be used depending upon the application and that the configurations shown and described herein are intended to be exemplary in natures.

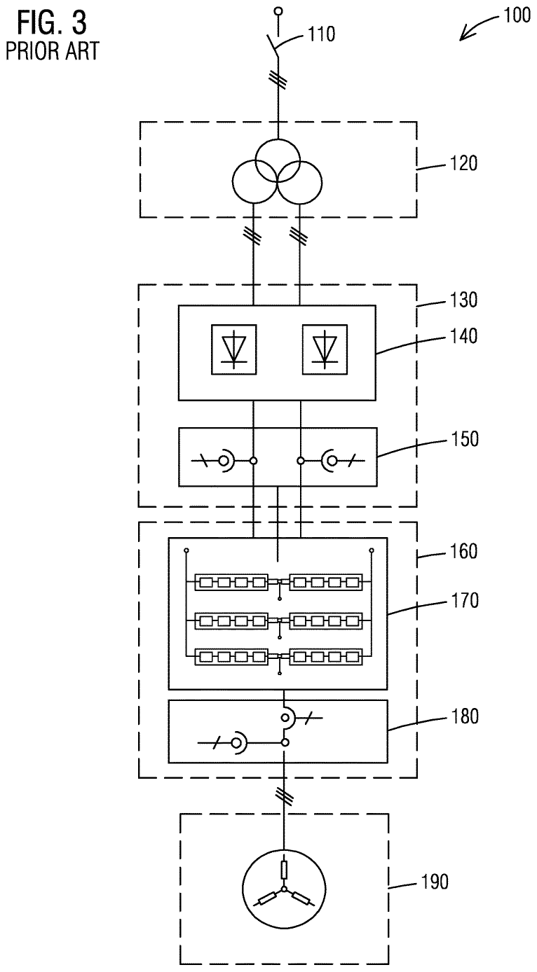

FIG. 3 illustrates a schematic of a basic configuration of a modular multilevel converter system 100 in accordance with an exemplary embodiment described herein. In an example, the converter system 100 comprises a basic input module 130 and an output module 160 deploying M2C or M2LC technology. The basic input module 130 generates a DC voltage and provides energy for the output module 160 connected to the basic input module 130. In an example, the basic input module 130 can comprise series-connected six-pulse rectifiers 140. The output module 160 provides power for a connected motor 190, which can be for example a high voltage AC motor. The output module 160 is supplied with power for the motor 190 via the basic input module 130, which represents a DC link. The output module 160 comprises an inverter unit 170 with M2C or M2LC technology comprising multiple semiconductors, in particular Insulated Gate Bipolar Transistors (IGBTs). The output module 160 including M2C or M2LC subsystems, herein also referred to as power cells, provides the motor 190 with almost sinusoidal voltages. In an example, the inverter 170 can comprises three phases. Each phase comprises two so-called M2C or M2LC branches. The six branches of the inverter 170 each consist of identical subsystems (power cells) connected in series.

FIG. 3 further illustrates a circuit-breaker 110 and transformer 120 as an example for a power supply for the converter system 100. Furthermore, the converter system 100 can comprise one or more measuring units 150, 180 used to measure voltages and currents. For example, measuring unit 150 measures voltages and currents of the basic line module 130, and measuring unit 180 measures voltages and currents on the motor side. Voltages can be measured using AVT (actual value transmission) combination modules, currents can be measured using electronic current transformers and AVT combination modules. The AVT combination modules convert analog signals into digital signals and transfer the signals to a control unit for example via fiber-optic cables. It should be noted that the converter system 100 of FIG. 3 may comprise more components, such as for example control module(s), cooling module(s), braking module(s) and/or bypass module(s). Control module(s) are typically used for open-loop and closed-loop control of the drive as well as operating control and diagnostics of the drive.

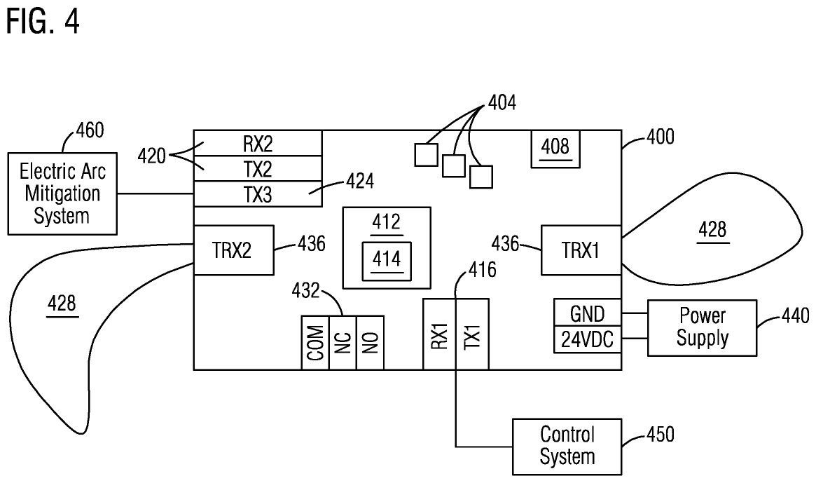

FIG. 4 illustrates a schematic diagram of a sensor board 400 for a drive system in accordance with an exemplary embodiment of the present disclosure. The sensor board is herein also referred to as ‘smart sensor board’. The sensor board 400 may be used for drive systems, such as described with reference to FIG. 1, FIG. 2, and FIG. 3.

The smart sensor board is an integrated system which acquires multiple types of data and performs analysis for both local and remote data processing. The multiple data which are acquired independently from multiple on-board and/or off-board sensors are utilized for real time drive performance analysis, improvement, protection, and critical component life estimation. In an example, the smart sensor board is an element of a variable frequency drive (VFD) and configured to acquire and process data and information of the VFD,

The sensor board 400 comprises a plurality of on-board sensors 404 configured to measure different environmental conditions. The sensors 404 are disposed on the sensor board 400 and monitor various characteristics and values of a drive system. For example, the sensors 404 include sensors for measuring and monitoring input voltage, output voltage, input current, output current of the power converter, internal temperatures the transformer and/or power converter and/or cooling assemblies. The sensors 404 provide sensor data, such as values and/or measurements of ambient temperature, vibration, current, voltage, relative humidity, barometric pressure, sound level, various chemical gas concentrations, etc. It should be noted that FIG. 4 illustrates an exemplary number of three on-board sensors 404, wherein the sensor board 400 may comprise more than three sensors 404.

The smart sensor board 400 further comprises an isolated controller area network (CAN) bus interface (408) for connecting to one or more off-board sensor(s). Off-board sensors are not disposed on the sensor board but are located remotely to the sensor board 400. The data and information of the off-board sensor are transmitted to the sensor board via a CAN bus so that the sensor board 400 can receive and process the data and information of the on-board sensors 404 as well as off-board sensors. Off-board sensors can be located within a drive system or drive cabinet, for example at specific locations to measure specific conditions, such as a heat sink sensor and an air flow sensor for measuring internal temperature and air flow of a power converter or a transformer.

Further, the sensor board 400 comprises a power supply 440, and at least one processor 412 configured to receive and process data in different data formats from the plurality of on-board sensors 404 and/or off-board sensors, and an interface 416 to a control system 450 or data processing system, wherein acquired data in the different data formats are transmitted to the control system 450 or data processing system in a unified data format or communication protocol. The control system 450 or data processing system is a higher ranking system and can be for example the controller 18 of the drive system as illustrated in FIG. 1 and FIG. 2. The control system 450 comprises at least one processor and other components for processing and controlling purposes. A data processing system can include industrial computers, programmable logic controllers (PLCs), data acquisition systems, etc., wherein the sensor data are transmitted for processing and/or displaying by the data processing system(s).

The at least one processor 412 is configured to communicate with the plurality of on-board sensors 404 via various communication busses corresponding to their different data formats. The different data formats include analog signals and digital signals. Further, to provide the unified data format and suitable communication protocol, the processor 412 comprises an internal analog-to-digital (A/D) converter 414. Analog signals are converted into digital signals utilizing the A/D converter 414. The unified data format is for example a digital signal data format. The processor 412 with internal A/D converter 414 provides a compact one chip solution for both analog and digital signals from various sensors and transducers.

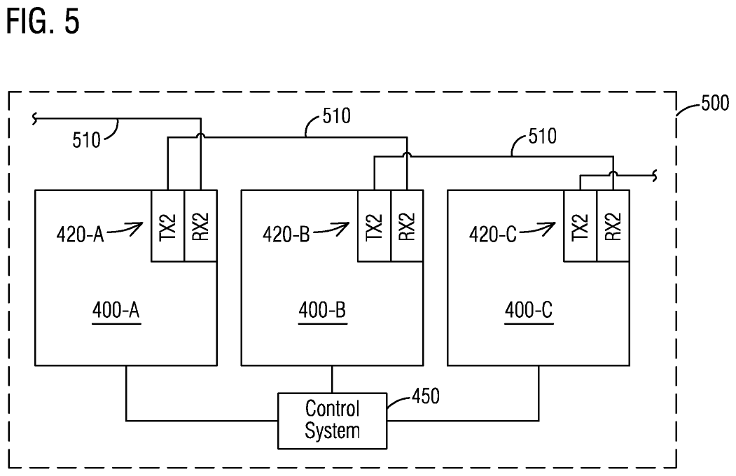

The sensor board 400 further comprises one or more interfaces 420 to connect to other sensor boards. Further details are described in connection with FIG. 5.

In another exemplary embodiment, the smart sensor board 400 has an ability to independently sensing an electric arc within a switchgear, cabinet, or drive system, e. g. VFD, such as a medium voltage (MV) VFD. More specifically, the sensor board 400 further comprises an electric are flash detecting mechanism, wherein upon an electric arc detection, the medium voltage of the drive system is interrupted.

The drive system, such as a MV VFD, is typically housed in an enclosure or cabinet. Electric arcs, also referred to as arc faults or arc flash, may occur within enclosures or cabinets due to for example faulty connections. An internal short circuit may result in an arc fault. Air is ionized between two or more potentials in the electric device by the arc fault, causing an arc flash comprising a plasma cloud of rapidly expanding vaporized metallic materials. The plasma causes high pressures and temperatures to build up quickly, in fractions of a second, within the enclosure. The arc fault conditions must either be contained within the enclosure or vented to the outside of the electric device enclosure.

Arc fault effects are devastating for the equipment where it occurs and secondary effects such as explosive elimination of shrapnel and toxic gases cause serious hazards for personnel. While the electric arc is burning, significant damage of components inside the cabinet occurs in part due to the uncontrolled way the are is burning. Additionally, the electric arc tends to move inside the cabinet away from the source of energy. This way the damage inside is substantial and as a rule causes permanent damage to the entire cabinet and its contents.

Thus, the sensor board 400 comprises an interface 424 to an electric arc mitigation system 460 including dedicated transmitters and receivers for triggering the electric arc mitigation system 460 capable of quenching an electric arc.

The electric arc flash detecting mechanism comprises one or more transparent fibre optic cable(s) 428 for the electric arc detection, one or more onboard analog transceiver(s) 436 (TRX1, TRX2), and a relay 432 for interrupting the voltage. The one or more fibre optic cables 428 can be many meters long and are arranged within the drive enclosure cabinet. The fibre optic cables 428 can sense the light characteristics of an electric arc. Characteristics of an electric arc include current, specifically overcurrent, and light, specifically flashlight.

Upon an electric arc detection, based for example on flashlight, the sensor board can toggle the relay 432 which then interrupts the drive input medium voltage. In addition, the board 400 has dedicated fibre optic transmitters and receivers for wiring multiple boards 400 together and for triggering the electric arc mitigation system 460 including an arc quenching device. Upon receiving an arc fault signal, an arc quenching device is activated and performs quenching of the arc and sends a trip signal to a circuit breaker. The circuit breaker disconnects a power source of the drive system. In case of multiple sensor boards 400 wired together, only one sensor board 400 needs a connection to the electric arc mitigation system 460, and protection is provided to all areas covered by different sensor boards 400 through the fibre optic cables connecting the sensor boards 400.

Multiple sensor boards 400 may be connected in a daisy chain to provide protection in multiple compartments or multiple drives. A VFD can comprise several sensor boards 400 distributed throughout the VFD.

Further, the smart sensor board 400 can comprise one or more analog input interface channels where analog signals from current transducers may be connected in case the arc flash detection needs to be conditioned by the presence of both light and current as opposed to just light (default mode).

In another embodiment, the sensor board 400 comprises an on-board microphone configured to detect sound in a certain frequency range utilized by the processor for sound analysis. For example, the on-board microphone can be configured to detect sound in a frequency range from 20 Hz to 20 KHz which may be used by the processor 412 for various sound analysis of various drive components such as fans, blowers, transformers, etc.

In another embodiment, the sensor board 400 is configured to independently measure ambient temperature and humidity of the location of the board 400 as well as to monitor presence of various chemical gases, such as SO2, H2S, O3, etc., utilizing corresponding chemical sensors. Further, the sensor board 400 may comprise a barometric pressure sensor coupled to the on-board processor 412, for example by an I2C bus, Further, the sensor board 400 may comprise a relative humidity sensor coupled to the on-board processor 412, for example by an I2C bus.

In another exemplary embodiment, the sensor board 400 comprises one or more digital thermopiles capable of forming thermal images from various locations inside the drive system or cabinet such as input connections, output connections, power transformer, etc. The thermal images are processed by the processor 412 configured to analyse the thermal images, determine maximum, minimum, or average temperature as well as transfer the thermal image(s) for further processing, for example to another device or system, such as the control system 450 or a remote data acquisition and/or processing system.

FIG. 5 illustrates a schematic diagram of a variable frequency drive (VFD) 500 comprising multiple sensor boards in accordance with an exemplary embodiment of the present disclosure.

The VFD 500 is only shown schematically and can be configured as illustrated and described with reference to FIG. 1, FIG. 2, or FIG. 3. The VFD 500 comprises, amongst many other components, a power circuit comprising a plurality of power cells supplying power to output phases (A, B, C), a control system 450 in communication with the plurality of power cells and controlling operation of the plurality of power cells, and at least one sensor board 400-A, 400-B, 400-C.

Each sensor board 400-A, 400-B and 400-C is configured as described with reference to FIG. 4. Thus, each sensor board 400-A, 400-B, 400-C comprises a plurality of on-board sensors 404 configured to measure different environmental conditions, an isolated CAN bus interface 408 for connecting to one or more off-board sensor(s), a processor 412 configured to receive and process data in different data formats from the plurality of on-board sensors 404 and the one or more off-board sensor(s), and an interface 416 to the control system 450 or data processing system, wherein acquired data in the different data formats are transmitted to the control system 450 or data processing system in a unified data format and communication protocol.

As shown in FIG. 5, the VFD 500 comprises multiple sensor boards 400-A, 400-B, 400-C coupled to each other in a daisy chain connection, i. e. wired together in a sequence or in a ring.

Each sensor board 400-A, 400-B, 400-C comprises interfaces 420-A, 420-B, 420-C for connecting to the other sensor boards. The sensor boards 400-A, 400-B, 400-C are coupled to each other by fibre optic cables 510. Sensor board 400-A is coupled to a previous sensor board (not illustrated) via 420-A RX2 (receiver) interface. Further, sensor board 400-A is coupled to sensor board 400-B via interface 420-A TX2 (transmitter) interface and 420-B RX2 (receiver) interface. Sensor board 400-B is coupled to sensor board 400-C via 420-B TX2 (transmitter) interface and 420-C RX2 (receiver) interface. Sensor board 400-C may be coupled to another sensor board or to the electric arc mitigation system 360 via 420-C TX2 interface.

At least one sensor board or all sensor boards 400-A, 400-B, 400-C is/are connected to the control system 450, for example via a duplex fibre optic cable(s), for transmission of the acquired sensor data. The sensor board(s) 400-A, 400-B, 400-C may transmit other data to the control system 450. If less than all sensor boards are connected to the control system 450, the connected sensor board(s) may collect sensor data from sensor boards that are not connected to the control system 450 and then transmit those data to the control system 450.

The sensor boards 400-A, 400-B, 400-C and the control system 450 are configured to perform real-time drive performance analysis, improvement, protection, and critical component life estimation. For example, sensor data, such as temperature data, acquired by the sensor board(s) 400 are processed and transmitted to the control system 450. If the temperature is above a certain value (threshold), which means that certain sections of the VFD 500 may be overheating, the control system 450 can activate and control cooling assemblies such as fan or blowers to cool the identified sections of the VFD 500.

It should be appreciated that acts associated with the above-described methodologies, features, and functions (other than any described manual acts) may be carried out by one or more data processing systems, via operation of at least one processor 412 and/or control system 450 with processor. As used herein, a processor corresponds to any electronic device that is configured via hardware circuits, software, and/or firmware to process data. For example, processors described herein may correspond to one or more (or a combination) of microprocessor, CPU, or any other integrated circuit (IC) or other type of circuit that is capable of processing data in a data processing system, The at least one processor 412 and/or control system 450 that is described or claimed as being configured to carry out a particular described/claimed process or function may correspond to a CPU that executes computer/processor executable instructions stored in a memory in form of software and/or firmware to carry out such a described/claimed process or function. However, it should also be appreciated that such a processor may correspond to an IC that is hard wired with processing circuitry (e.g., an FPGA or ASIC IC) to carry out such a described/claimed process or function. Further, it should be understood, that reference to “a processor” may include multiple physical processors or cores that are configured to carry out the functions described herein.

What is claimed is:

1.-20. (canceled)

21. A sensor board, comprising:
a plurality of on-board sensors configured to measure different environmental conditions;
a network interface configured to connect to at least one off-board sensor;
a processor configured to receive and process data in different data formats from a plurality of on-board sensors and the at least one off-board sensor; and
a first interface configured to connect to a control system or a data processing system,
wherein acquired data in the different data formats are transmitted to the control system or the data processing system in a unified data format.

22. The sensor board of claim 21, wherein the network interface comprises an isolated controller area network (CAN) bus interface.

23. The sensor board of claim 21, wherein the processor is configured to communicate with the plurality of onboard sensors via various communication busses corresponding to the different data formats.

24. The sensor board of claim 21, wherein the different data formats include analog signals and digital signals, and wherein the processor comprises an internal analog-to-digital (A/D) converter for providing the unified data format.

25. The sensor board of claim 21, further comprising at least one second interface configured to connect to other sensor boards.

26. The sensor board of claim 21, further comprising an electric arc flash detecting mechanism, wherein upon an electric arc flash detection, an input medium voltage of a drive is interrupted.

27. The sensor board of claim 26, further comprising a third interface configured to connect to an electric arc mitigation system including dedicated transmitters and receivers for triggering the electric arc mitigation system capable of quenching an electric arc.

28. The sensor board of claim 26, wherein the electric arc flash detecting mechanism comprises a transparent fiber optic cable for the electric arc flash detection, an analog transceiver, and a relay for interrupting the voltage.

29. The sensor board of claim 21, further comprising an on-board microphone configured to detect sound in a certain frequency range utilized by the processor for sound analysis.

30. The sensor board of claim 21, further comprising at least one digital thermopile configured to form thermal images from various locations, wherein the thermal images are processed by the processor configured to analyze the thermal images, determine maximum, minimum, or average temperature, and transfer the thermal images to another system for further processing.

31. A variable frequency drive, comprising:
a power circuit comprising a plurality of power cells supplying power to output phases;
a control system in communication with the plurality of power cells and controlling operation of the plurality of power cells; and
a sensor board comprising a plurality of on-board sensors configured to measure different environmental conditions, a network interface configured to connect to at least one off-board sensor, a processor configured to receive and process data in different data formats from a plurality of on-board sensors and the at least one off-board sensor, and a first interface configured to connect to the control system or a data processing system, wherein acquired data in the different data formats are transmitted to the control system or the data processing system in a unified data format.

32. The variable frequency drive of claim 31, further comprising a plurality of said sensor board wired together in a daisy chain connection.

33. The variable frequency drive of claim 32, wherein each of the sensor boards comprises interfaces configured to connect to other ones of the sensor boards, and wherein the sensor boards are wired to each other by fiber optic cables.

34. The variable frequency drive of claim 31, wherein the control system and the sensor board are connected via a duplex fiber optic cable.

35. The variable frequency drive of claim 31, wherein the sensor board comprises an electric arc flash detecting mechanism including a transparent fiber optic cable, and an analog transceiver configured to sense an electric arc flash within the variable frequency drive, cabinet, or switchgear of the variable frequency drive.

36. The variable frequency drive of claim 35, further comprising an second interface configured to connect to an electric arc mitigation system including dedicated transmitters and receivers for triggering the electric arc mitigation system capable of quenching the electric arc.

37. The variable frequency drive of claim 36, further comprising a plurality of said sensor board, wherein, when the sensors boards are wired together, less than all of the sensor boards is/are connected to the electric arc mitigation system.

38. The variable frequency drive of claim 31, wherein the sensor board and the control system are configured to perform real-time drive performance analysis, improvement, protection, and critical component life estimation.

39. The variable frequency drive of claim 31, wherein the power circuit with the plurality of power cells is configured as M2C or M2CL subsystems.

40. The variable frequency drive of claim 31, wherein the power circuit with the plurality of power cells is configured as cascaded H-bridge subsystems.
